(19) United States
(12) Patent Application Publication
(10) Pub. No.: US 2024/0426706 A1
(43) Pub. Date: Dec. 26, 2024

(54) MODIFIED MASTER GEARWHEEL

(71) Applicant: Klingelnberg AG, Zürich (CH)

(72) Inventor: Sebastian Stramm, Köln (DE)

(21) Appl. No.: 18/743,320

(22) Filed: Jun. 14, 2024

(30) Foreign Application Priority Data
Jun. 20, 2023 (DE) 10 2023 116 045.1

(51) Int. Cl. G01M 13/021; B23F 23/12

(52) U.S. Cl. CPC G01M 13/021; B23F 23/1218

(57) ABSTRACT

A master gearwheel for the rolling test of gearings, wherein the master gearwheel has a gearing having a number of teeth, wherein the master gearwheel has at least two segments, wherein one tooth or several teeth of the teeth are assigned to each of the segments and wherein the teeth of one of the segments has a geometry which is different from the geometry of the teeth of another of the segments.

### CROSS-REFERENCE TO RELATED APPLICATIONS

This application claims the benefit of German patent application 10 2023 116 045.1, filed on 20 Jun. 2023, the disclosure of which is incorporated herein by reference in its entirety.

### TECHNICAL FIELD

The present disclosure relates to a master gearwheel for the rolling test of gearings, wherein the master gearwheel has a gearing having a plurality of teeth. The disclosure also relates to a method for the rolling test of gearings.

### BACKGROUND

The rolling test of gearings, also known as the rolling test, is used for quality assurance. A master gearwheel that is manufactured as perfectly as possible usually rolls with the gearing to be tested in such a way that each tooth or tooth flank of the gearing to be tested engages and rolls with each tooth of the master gearwheel in question. Since the master gearwheel in question has teeth with identical geometry according to the state of the art, wherein each individual tooth of the master gearwheel corresponds as precisely as possible to a specified nominal geometry, a large amount of redundant information or measurement data is generated during the aforementioned rolling test.

One disadvantage of the rolling test using such a master gearwheel is that the subsequent rolling behavior of the gearing to be tested cannot be predicted from this test in combination with the actual mating gear assigned in the installed state. All tolerance positions of the mating gear must therefore be taken into account when determining the rolling test tolerances. Furthermore, the usual evaluation of the deviations determined during the rolling test does not provide any information about the direction of the geometric deviations on the tested gearings in question.

### SUMMARY

Against this background, the present disclosure is based on the technical problem of providing a master gearwheel for the rolling test of gearings as well as a method for the rolling test of gearings, which enable a more practical testing of gearings and, in particular, can obtain less redundant but, compared to the classic rolling test, more information on the rolling behavior of the gearing to be tested.

The technical problem described above is solved in each case by means of the independent claims. Further embodiments of the disclosure result from the dependent claims and the following description.

According to a first aspect, the disclosure relates to a master gearwheel for the rolling test of gearings, wherein the master gearwheel has a gearing having a plurality of teeth. The master gearwheel is characterized in that the master gearwheel has at least two segments, wherein one tooth or several teeth of the plurality of teeth are assigned to each of the segments and wherein the at least one tooth or the teeth of one of the segments have a geometry which is different from the geometry of the at least one tooth or the teeth of another of the segments.

The disclosure is based on the idea of not designing the geometry of the teeth of the master gearwheel uniformly, but rather, for example, providing different geometric modifications segment by segment, which reflect, for example, the extremes or limit positions of the possible tolerance positions of the respective mating gear to a gearing to be tested.

For example, certain segments of the master gearwheel can simulate the worst case for certain gearing deviations of the mating gear, such as for a flank line angle deviation or a profile angle deviation. By evaluating the rotational errors resulting from the gear hobbing with these segments, it is possible to draw conclusions about the hobbing behavior of the gearing to be tested in operation with a mating gear that has a deviation corresponding to such a segment, for example.

The master gearwheel according to the disclosure therefore makes it possible, in particular, to obtain less redundant but, compared to the classic rolling test, more information on the rolling behavior of the gearing to be tested. For example, the behavior of the gearing to be tested can be tested in the event that a mating gear assigned in the fully assembled state has been manufactured for one or more gearing deviations close to the limits of the permissible tolerances.

According to one embodiment of the master gearwheel, it may be provided that at least one of the segments has two or more teeth, wherein the two or more teeth are arranged in particular adjacent to one another, or each of the segments has two or more teeth, wherein the two or more teeth of a respective segment are arranged in particular adjacent to one another.

Grouping adjacent teeth into segments has the advantage of simplifying the evaluation of the deviations determined in the rolling test, as specific deviations characteristic of a particular segment are repeated on successive teeth. In this way, the assignment of deviations measured during the rolling test to the segments can be automated, as the number of teeth per segment and the respective segment-specific tooth geometry are known in advance.

It may be provided that the master gearwheel has a known, segment-specific tooth geometry that has been recorded using tactile and/or optical coordinate measuring technology.

Each master gearwheel is basically a gear produced by means of a gear cutting process, which in turn has been manufactured within the technological possibilities of gear production and is therefore also subject to certain tolerances. Whereas, according to the prior art, the teeth of a master gearwheel should have as few deviations as possible from the nominal geometry of the mating gear, i.e. the master gearwheel is as perfectly manufactured a mating gear as possible, according to the disclosure, deviations are specifically introduced into the master gearwheel which, for example, reflect limit positions for certain gearing deviations of the mating gear within the tolerances of the mating gear.

The master gearwheel according to the disclosure can therefore have a nominal geometry modified segment by segment, wherein segment-specific limit positions are generated at the tolerance limits for one or more gearing deviations.

According to one embodiment of the master gearwheel, it is provided that one of the segments for at least one quality parameter of the gearing has a deviation from a predetermined nominal geometry which is more than 50% of a maximum permissible deviation for this quality parameter, in particular more than 75% of a maximum permissible deviation for this quality parameter, in particular more than 90% of a maximum permissible deviation for this quality parameter.

Such a quality parameter of the gearing can be, for example, a pitch deviation. Accordingly, a segment of the gearing, to which several neighboring teeth can be assigned, can have a pitch deviation that is more than 90% of a maximum permissible deviation for this quality parameter “pitch deviation”. This can be transferred to other common quality parameters or gearing deviations mentioned below in order to test the behavior of the gearing to be tested with regard to these gearing deviations or a combination of several gearing deviations in the course of the rolling test.

The quality parameters of the gearing can also be referred to as gearing deviations of the gearing, provided that a quality parameter has exactly one gearing deviation or exactly one gearing deviation is assigned to a quality parameter. For example, a quality parameter can be assigned exactly one gearing deviation. Alternatively, two or more gearing deviations can be assigned to a quality parameter.

According to one embodiment of the master gearwheel, it is provided that at least one of the segments, in particular exactly one of the segments, has a deviation from a predetermined nominal geometry for all quality parameters of the gearing which is less than 20% of a maximum permissible deviation for the quality parameters, in particular less than 10% of a maximum permissible deviation for the quality parameters, in particular less than 5% of a maximum permissible deviation for the quality parameters.

Such a segment thus represents the smallest possible deviations from an intended nominal geometry of the teeth of the mating gear, as would be usual for master gearwheels according to the prior art as a whole. This segment can therefore be used when evaluating the results of the rolling test in order to serve as a reference or to reflect the result of a classic rolling test with a perfect master gearwheel. In particular, a comparison of the results of the rolling test of the segment manufactured close to the perfect nominal geometry with the results of the segment manufactured in the area of a limit position can be used to estimate the sensitivity of the running behavior of the gearings to be tested in relation to the tolerances of the mating gear.

A quality parameter of the gearing may have one or more deviations selected from: Profile deviations, such as the total profile deviation, the profile shape deviation, the profile angle deviation, the pressure angle deviation, or the like, and/or the deviations of one or more tooth flank modifications in the profile direction, such as deviations of the height crowning, the tip and/or root relief, the profile angle modification, the profile entanglement, or the like; flank line deviations, such as the total flank line deviation, the flank line shape deviation, the flank line angle deviation, the spiral angle deviation or the like and/or the deviations of one or more tooth flank modifications in the flank direction, such as deviations of the width crowning, the end reliefs, the flank line angle modification, the flank line entanglement or the like; pitch deviations, such as the individual pitch deviation, the pitch sum deviation, the pitch step or the like; tooth thickness deviations; radial runout deviations; axial runout deviations; flatness deviations; torsion/entanglement.

It may be provided that the master gearwheel has at least three segments or has exactly three segments and/or the master gearwheel has been produced in single indexing by profile grinding. With the help of profile grinding, the individual gaps or teeth of the master gearwheel can be manufactured individually so that different tooth geometries can be produced in the different segments.

According to a second aspect, the disclosure relates to a method comprising the following method steps: Rolling test of a gearing to be tested, wherein the gearing to be tested rolls with a master gearwheel and wherein the master gearwheel is formed in a manner according to the disclosure.

The method according to the disclosure makes it possible, in particular, to obtain less redundant but, compared to the classic rolling test, more information on the rolling behavior of the gearing to be tested. For example, the behavior of the gearing to be tested can be tested in the event that a mating gear assigned in the fully assembled state has been manufactured for one or more gearing deviations close to the limits of the permissible tolerances.

It may be provided that a rotation angle of the gearing to be tested and/or the master gearwheel is recorded during the rolling test, that rotation angle ranges are assigned to the segments and that a segment-specific evaluation of the deviations recorded by means of the rolling test is carried out using the rotation angle ranges and segment-specific deviations are specified.

According to one embodiment of the method, it may be provided that the rolling test comprises a single flank rolling test. According to one embodiment of the method, it may be provided that the rolling test comprises a double flank rolling test.

It may be provided that one or more of the deviations listed below are determined for at least one segment-specific evaluation or for several segment-specific evaluations: Runout, rolling deviation, runout error, tooth-to-tooth amplitude, maximum rolling deviation, transmission error and dynamic backlash, noise behavior, surface error.

According to one embodiment of the method, it may be provided that an automated assignment of the segments to deviations measured on the gearing to be tested takes place, wherein in particular a marking of the master gearwheel and a marking of the gearing to be tested are detected, which enable an assignment of the teeth in mesh.

Alternatively or additionally, the segments can be assigned to corresponding rotation angle ranges based on the measured deviations. This is because for certain segments whose gearing deviations have been manufactured in the limit position of a tolerance zone, characteristic rotational errors are to be expected, which change abruptly at the transition to the other segments that do not have these gearing deviations in the limit position of a tolerance zone.

### BRIEF DESCRIPTION OF THE DRAWINGS

The disclosure is described in more detail below with reference to drawings illustrating exemplary embodiments, which schematically show in each case as follows:

FIG. 1 shows a master gearwheel according to the disclosure;

FIG. 2 shows the master gearwheel according to the disclosure from FIG. 1 with segments;

FIG. 3 shows a single flank rolling test; and

FIG. 4 shows a result of a single flank rolling test.

### DETAILED DESCRIPTION OF THE DRAWINGS

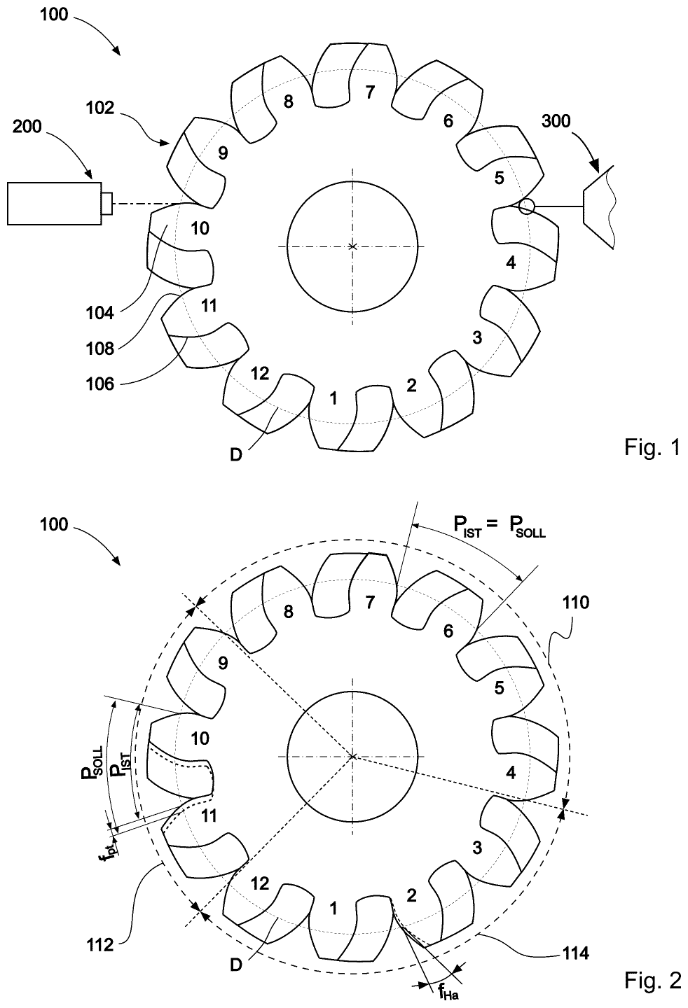

FIG. 1 shows a master gearwheel 100 according to the disclosure. The master gearwheel 100 is used for the rolling test of gearings. The master gearwheel 100 has a gearing 102 with a plurality of teeth 104. The teeth 104 of the master gearwheel 100 are numbered counterclockwise with the digits 1-12. Each of the teeth 104 has a left-hand flank 106 and a right-hand flank 108.

In the present case, the master gearwheel 100 has three segments 110, 112, 114, wherein each of the segments 110, 112, 114 is assigned several teeth 104 of the plurality of teeth 104.

The teeth 104 with the numbers 4, 5, 6, 7, 8 are assigned to segment 110. The teeth 104 with the numbers 9, 10, 11 are assigned to segment 112. The teeth 104 with the numbers 1, 2, 3, 12 are assigned to segment 114.

The teeth 104 of the segment 110 have a geometry that is different from the geometry of the teeth 104 of the segments 112 and 114. The teeth 104 of segment 112 have a geometry that differs from the geometry of the teeth 104 of segment 114.

Within a respective segment 110, 112, 114, the teeth 104 assigned to the respective segment have the same geometry for each segment. The master gearwheel 100 therefore has three different tooth geometries.

The teeth 104 of a respective segment 110, 112, 114 are each arranged adjacent to one another.

The different tooth geometries of the segments 110, 112, 114 are used here to represent limit positions in the area of the edges of the maximum permissible tolerances for certain gearing deviations in order to be able to evaluate the effects of these deviations on the rolling behavior of the gearing to be tested as part of a rolling test of a gearing.

In this example, segment 110 serves as a reference or represents the case of a classic master gearwheel manufactured as precisely as possible with the smallest possible deviations from a specified nominal geometry. Thus, a deviation of the teeth 104 of the segment 110 for all examined quality parameters of the gearing 102 is less than 5% of a maximum permissible deviation for the quality parameters. As is usual in the case of a classic master gearwheel, the teeth 104 of the segment 110 are therefore manufactured as perfectly as possible.

For the simple and easy-to-understand example of a pitch deviation, it therefore applies to segment 110 that the tooth pitch on the pitch circle D is essentially deviation-free and therefore the manufactured actual pitch P_{IST} is equal to the required nominal pitch P_{SOLL}.

In contrast, it is provided for the segment 112 that for the quality parameter “tooth pitch” between the respective teeth 104, an individual pitch deviation f_{PT} is provided in each case which is greater than 75% of the maximum permissible individual pitch deviation f_{PT_max}.

The segment 114 has essentially no pitch error, but has a profile angle deviation f_{Ha} for each of the teeth 104 of the segment 114 that is greater than 75% of a maximum permissible profile angle deviation f_{Ha_max}.

The segments 112 and 114 therefore have limit positions for the pitch deviation and the profile angle deviation at the edges of the maximum permissible deviations for these quality parameters in order to determine their effect on the rolling behavior of a gearing to be tested during the rolling test. The essentially deviation-free segment 110 serves as a reference.

The exact actual geometry of the master gearwheel 100 can be determined using a gear measurement. For example, an optical device 200 can be used for gear measurement. Alternatively or additionally, a tactile device 300 can be used for gear measurement. The tactile device 300 for gear measurement and/or the optical device 200 for gear measurement can be part of a coordinate measuring machine with a rotary table. During the measurement, the master gearwheel to be measured can be clamped on the rotary table and rotated about its own axis with the aid of the rotary table.

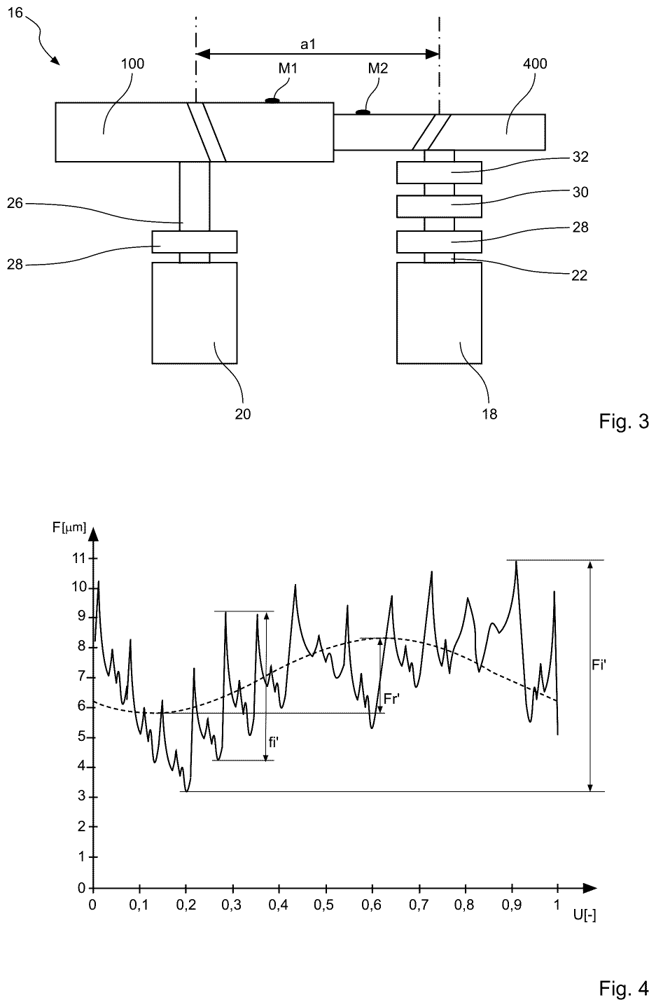

FIG. 3 shows a method according to the disclosure, namely the performance of a single flank rolling test of a toothed component 400 using the master gearwheel 100 according to the disclosure.

The master gearwheel 100 has helical teeth, as can be seen in the schematic diagram in FIGS. 1 and 2. The design of the master gearwheel 100 is not relevant to the disclosure. The master gearwheel 100 can therefore be a spur gear with straight teeth, a helical spur gear with helical teeth, a bevel gear or the like. This applies equally to the method according to the disclosure which is also not limited by the design or type of gearing.

FIG. 3 shows an example of the schematic structure of a test stand 16 for carrying out a single flank rolling test.

The test stand 16 has a first drive 18 and a second drive 20. The first drive 18 is set up to drive a first shaft 22, on which the toothed component 400 to be tested is mounted.

The second drive 20 is used to brake the master gearwheel 100, which is mounted on a second shaft 26 coupled to the drive 20.

The master gearwheel 100 is an externally toothed spur gear that meshes with the gearing of the component 400. By driving the toothed component 400 and simultaneously braking the master gearwheel 100, a speed and a torque can be set during the test run. It is understood that speed and torque curves can also be set. A center distance al between the shafts 22, 26 is constant.

The test stand 16 has rotary encoders or angle measuring systems 28, a rotational acceleration sensor 30 and a structure-borne sound sensor 32.

FIG. 4 shows a schematic example of the measured rotational error F in [μm] plotted over one revolution U of the gearwheel 400—i.e. a result of a single flank rolling test of the toothed component 400. From this, values for the first-order runout Fr′, the tooth-to-tooth amplitude fi′ and the maximum rolling deviation Fi′, for example, can be determined in a known manner.

The result shown in FIG. 4 is only to be understood as an example and does not reflect the actual result of a rolling test of a gearing 400 with the segment-specific deviations of the master gearwheel 100 shown in FIG. 2. This is because the segment-specific deviations of the master gearwheel 100 shown in FIG. 2 are also to be understood merely as examples to illustrate the concept according to the disclosure. For each of the segments 110, 112, 114, a superposition of different gear deviations can be provided in order to determine their influence on the rolling behavior of a respective gearing 400 to be tested.

An automated assignment of the segments 110, 112, 114 to deviations measured on the gearing 400 to be tested can be carried out, wherein a marking M1 of the master gearwheel 100 and a marking M2 of the gearing 400 to be tested are recorded, which enable an assignment of the teeth in mesh.

1. A master gearwheel for the rolling test of gearings,
wherein the master gearwheel has a gearing having a plurality of teeth, characterized in that
the master gearwheel has at least two segments,
wherein one tooth or several teeth of the plurality of teeth are assigned to each of the segments and
wherein the at least one tooth or teeth of one of the segments has a geometry which is different from the geometry of the at least one tooth or the teeth of another of the segments.

2. The master gearwheel according to claim 1, wherein
at least one of the segments has two or more teeth, wherein the two or more teeth are arranged adjacent to one another, or
each of the segments has two or more teeth, wherein the two or more teeth of a respective segment are arranged adjacent to one another.

3. The master gearwheel according to claim 1,
one of the segments for at least one quality parameter of the gearing has a deviation from a predetermined nominal geometry which is more than 50% of a maximum permissible deviation for this quality parameter, and/or
at least one of the segments has a deviation from a predetermined nominal geometry for all quality parameters of the gearing which is less than 20% of a maximum permissible deviation for the quality parameters.

4. The master gearwheel according to claim 3, wherein
a quality parameter of the gearing has one or more deviations, selected from:
profile deviations, such as the total profile deviation, the profile shape deviation, the profile angle deviation, the pressure angle deviation, and/or the deviations of one or more tooth flank modifications in the profile direction, such as deviations of the height crowning, the tip and/or root relief, the profile angle modification, the profile entanglement;
flank line deviations, such as the total flank line deviation, the flank line shape deviation, the flank line angle deviation, the spiral angle deviation and/or the deviations of one or more tooth flank modifications in the flank direction, such as deviations of the width crowning, the end relief, the flank line angle modification, the flank line entanglement;
pitch deviations, such as the individual pitch deviation, the pitch sum deviation, the pitch step;
tooth thickness deviations;
radial runout deviations;
axial runout deviations;
flatness deviations;
torsion/entanglement.

5. The master gearwheel according to claim 1, wherein
the master gearwheel has at least three segments or has exactly three segments and/or
the master gearwheel has been produced in single indexing by profile grinding.

6. A method including the following steps:
rolling test of a gearing to be tested,
wherein the gearing to be tested rolls with a master gearwheel, and
wherein the master gearwheel is formed according to claim 1.

7. The method according to claim 6, wherein
a rotation angle of the gearing to be tested and/or of the master gearwheel is recorded during the rolling test,
rotation angle ranges are assigned to the segments, and
a segment-specific evaluation of the deviations recorded by means of the rolling test is carried out using the rotation angle ranges and segment-specific deviations are specified.

8. The method according to claim 6,
wherein the rolling test comprises a single flank rolling test.

9. The method according to claim 8,
wherein one or more of the deviations listed below are determined for at least one segment-specific evaluation or for several segment-specific evaluations runout, rolling deviation, runout error, tooth-to-tooth amplitude, maximum rolling deviation, transmission error and dynamic backlash, noise behavior, surface error.

10. The method according to claim 6, wherein
the automated assignment of the segments to deviations measured on the gearing to be tested takes place,
wherein a marking of the master gearwheel and a marking of the gearing to be tested are detected, which enable an assignment of the teeth in mesh.
